(19) United States
(12) Patent Application Publication
(10) Pub. No.: US 2011/0187333 A1
(43) Pub. Date: Aug. 4, 2011

(54) ENERGY-SAVING POWER CONVERTING APPARATUS CAPABLE OF BEING WAKED UP AUTOMATICALLY AND HAVING SUSPEND MODE

(75) Inventor: Kuan Chun Wang, Taipei (TW)

(73) Assignee: KERIO TECHNOLOGIES, INC, Taipei (TW)

(21) Appl. No.: 12/948,763

(22) Filed: Nov. 18, 2010

(30) Foreign Application Priority Data
Feb. 2, 2010 (TW) 99103007

(51) Int. Cl. G05F 1/10

(52) U.S. Cl. 323/234

(57) ABSTRACT

The present invention relates to an energy-saving power converting apparatus. The apparatus includes a power converter for providing electric power to an electricity consuming device and a state indicator adapted for being connected to a standard interface of the electricity consuming device. The state indicator is configured to be activated upon receiving power from the power terminal of the standard interface of the electricity consuming device when the electricity consuming device is in the working mode, while the state indicator cannot receive power from the power terminal when the electricity consuming device is in the non-working mode. The power converting apparatus further includes a receiving and controlling unit for placing a control switch in an electrically connected state to activate the voltage-transforming unit when the electricity consuming device is in the working mode.

### FIELD OF THE INVENTION

The present invention relates to a power converting apparatus, and more particularly, to an energy-saving power converting apparatus that is capable of being waked up automatically and has a suspend mode.

### DESCRIPTION OF THE RELATED ART

As energy saving has become a social consensus, many electricity consuming devices, such as a personal computer, are designed to possess a function of being automatically placed in a standby or suspend mode where the electric power is consumed at a minimum level, when the devices have been idle for a period of time. The personal computer would remain in the state until it is “waked up” by a user's touch on a computer mouse or a key on the keyboard and resumed to a normal operation state, thereby achieving the energy-saving purpose.

As shown in FIG. 1, a conventional power converting apparatus 3 includes an input port 31 (namely, a plug) adapted for coupling to a wall socket 2, a voltage converter 30 for converting the alternating-current (AC) power taken from the wall socket 2 into a direct-current (DC) power at a voltage level appropriate to the needs of an electricity consuming device 1 to be powered, such as a computer, and an output port 308 for transmitting the converted power to the electricity consuming device 1. Further referring to FIG. 2, a voltage-transforming unit 305 mainly includes inductance coils 303 for converting voltage. The voltage-transforming unit 305 is normally provided with a so-called primary side circuit 302 which extends from the input port 31 (namely, the plug) to the inductance coils 303. Taking advantage of the electromagnetic induction effect, the voltage coming from the primary side circuit 302 is modulated by the inductance coils 303 as a function of the turns ratio of a primary coil 3031 to a secondary coil 3032 and transmitted to a secondary side circuit 304 connected to the output port 308. The converted voltage is output after being rectified and filtered.

Since power sockets are normally located around corners of a room or on wall areas under a desk, quite a few users are reluctant to pull out plugs from the sockets when electricity consuming devices are not in use. As a result, even if a laptop computer is put in a standby mode for saving energy, the accompanying power converter will still take power from a wall socket and the inductance coils keep converting the AC voltage at the primary side into another voltage at the secondary side. However, the converted energy is wasted and dissipated into the atmosphere in the form of heat energy, as the output port does not provide power at this moment.

In other words, the primary side circuit and the secondary side circuit in the above case are both placed in the needless power-consuming and heat-generating state, which is in contradiction to the original object of power saving. Furthermore, keeping a power converting apparatus in continuous operation may result in a shortened lifespan of the apparatus. Efforts should be made to effectively halt the operation of a power converting apparatus when it need not supply power. It should be understood that the mere interruption of the secondary side circuit is rather insufficient to achieve the energy-saving purpose, and that the primary side circuit is a more appropriate target to be interrupted for the purpose of preventing the primary side circuit and the inductance coils from continuously consuming energy. However, an additional problem arises as to how the power converting apparatus, after the primary side circuit is interrupted, can be brought back to provide power to the electricity consuming device when a user returns to operate the electricity consuming device.

Therefore, there exists a need for a power converter that can be placed in an energy-saving state in response to an inactive mode of an electricity consuming device to which it is connected, thereby effectively saving the energy consumption. The power converter can also be resumed to a normal operating state in response to an active mode of the electricity consuming device. The power converter can thus satisfy the customers' needs and provide a useful solution to energy-saving and carbon reduction.

### SUMMARY OF THE INVENTION

Accordingly, an object of the present invention is to provide an energy-saving power converting apparatus capable of being waked up automatically and having a suspend mode, whose inductance coils and secondary side circuit will stop consuming energy when an electricity consuming device to which it is connected is placed in a non-working state.

Another object of the invention is to provide an energy-saving power converting apparatus capable of being waked up automatically and having a suspend mode, which can be brought back to a normal operating state in an automatic manner when an electricity consuming device to which it is connected is resumed to a working state.

It is still another object of the invention to provide an energy-saving power converting apparatus capable of being waked up automatically and having a suspend mode, which utilizes a state indicator connected to a standard interface of an electricity consuming device to automatically detect whether or not the standard interface is supplying power to find out the electricity consuming mode of the electricity consuming device at this time, thereby providing a user-friendly mechanism for energy saving.

According to the disclosure provided herein, the inventive energy-saving power converting apparatus capable of being waked up automatically and having a suspend mode is adapted for providing electric power to an electricity consuming device. The electricity consuming device has at least two electricity consuming modes, including a working mode and a non-working mode. The electricity consuming device also has a standard plug-and-play type interface having at least one power terminal and at least one signal terminal. The power converting apparatus comprises a state indicator and a power converter. The state indicator is adapted for being connected to the standard interface, wherein the state indicator is activated upon receiving power from the power terminal of the standard interface of the electricity consuming device when the electricity consuming device is in the working mode, and wherein the state indicator cannot receive power from the power terminal when the electricity consuming device is in the non-working mode.

The power converter includes an output port for being electrically connected to the electricity consuming device; a voltage-transforming unit having a control switch and adapted for outputting at least one predetermined output voltage via the output port; and a receiving and controlling unit for, upon receipt of a signal output from the state indicator when the electricity consuming device is in the non-working mode, placing the control switch in an electrically disconnected state to deactivate the voltage-transforming unit, and for placing the control switch in an electrically connected state to activate the voltage-transforming unit when the electricity consuming device is in the working mode.

The receiving and controlling unit may include a transmission cord electrically connected to the state indicator. The transmission cord is preferably one adapted for being electrically connected to the power terminal to allow electric power to be transmitted from the power terminal to the receiving and controlling unit. The state indicator may optionally comprise a wireless signal emitting circuit, and the receiving and controlling unit may comprise a wireless signal receiving circuit corresponding to the wireless signal emitting circuit.

By virtue of the aforesaid configuration, the power converting apparatus disclosed herein can be notified, for example, that the electricity consuming device is turned off and therefore placed in a non-working state, using the state indicator coupled to the standard interface of the electricity consuming device. Upon receipt of such information, the receiving and controlling unit of the power converter places the control switch in an electrically disconnected state, whereby the voltage-transforming unit discontinues the voltage conversion operation and enters a suspend mode for saving energy. On the contrary, when the electricity consuming device is turned on and placed in a working state and therefore starts to consume energy, the state indicator will transmit another information to the receiving and controlling unit of the power converter upon receipt of electric power from the standard interface of the electricity consuming device, thereby placing the control switch in an electrically connected state. As a result, the voltage-transforming unit is waked up to provide electric power. The power converter therefore remarkably reduces the energy consumption during the course when the electricity consuming device need not be supplied with power. And when the electricity consuming device is resumed to operate, the power converter will wake up automatically without user's control. The invention has a user-friendly design for energy saving and successfully achieves the objects described above.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is schematic view of a conventional power converting apparatus to be connected to a wall socket and an electricity consuming device;

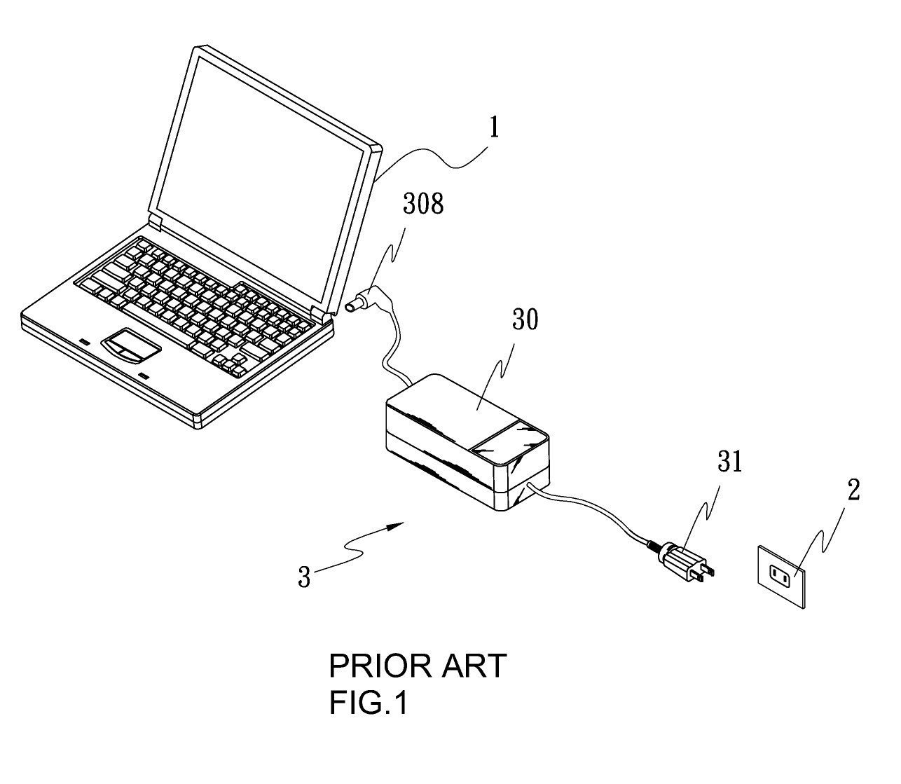

FIG. 2 is an internal circuit diagram of a power converter provided in the conventional power converting apparatus shown in FIG. 1;

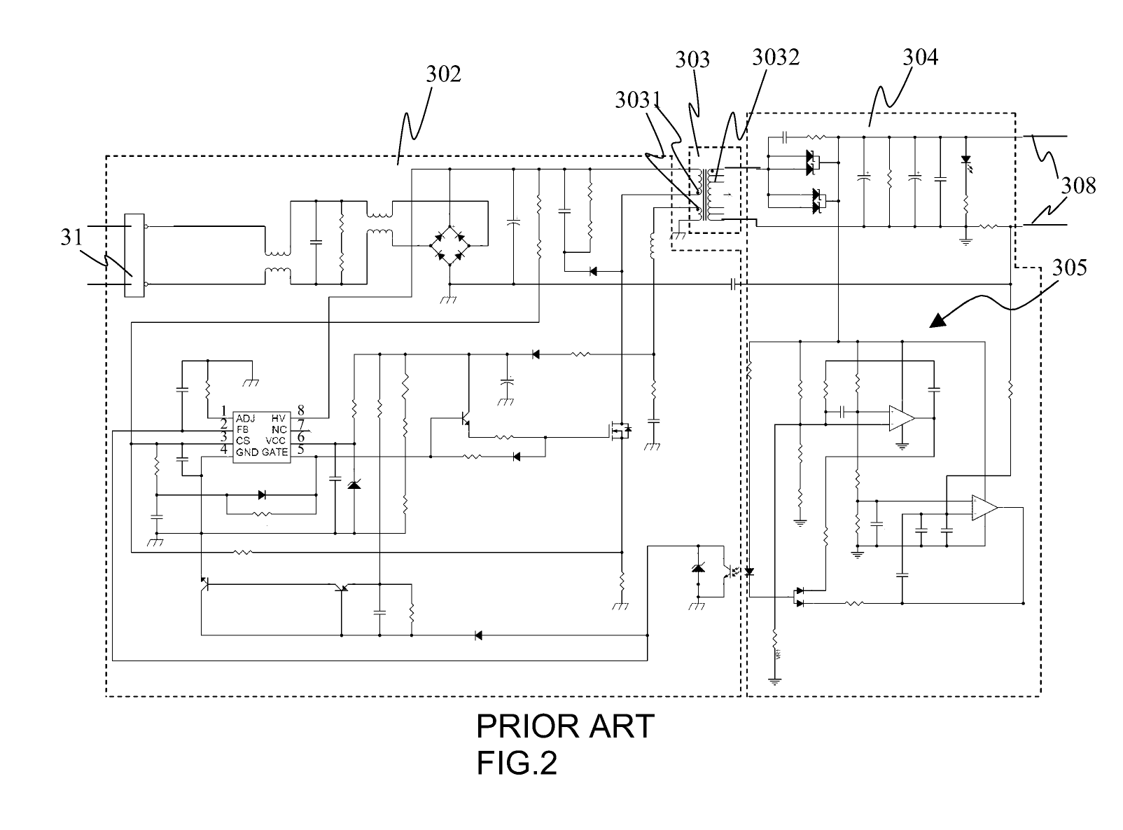

FIG. 3 is a schematic view of an energy-saving power converting apparatus capable of being waked up automatically and having a suspend mode according to the first preferred embodiment of the invention, in which the power converting apparatus is to be connected to a wall socket and an electricity consuming device, and the USB connection port of the electricity consuming device is to be connected to a state indicator from which a transmission cord extends to a power converter;

FIG. 4 is an internal circuit diagram of the power converter provided in the conventional power converting apparatus shown in FIG. 3, showing that the state indicator can transmit an electrical signal to the power converter via the transmission cord;

FIG. 5 is a schematic view of a power converting apparatus according to the second preferred embodiment of the invention, in which the state indicator is configured to transmit an electrical signal in a wireless manner;

FIG. 6 is an internal circuit diagram of the power converter provided in the conventional power converting apparatus shown in FIG. 5, showing that the state indicator can transmit an electrical signal to the power converter in a wireless manner; and

FIG. 7 is a circuit diagram according to the third preferred embodiment of the invention, in which a voltage-transforming unit is provided for performing voltage conversion by pulse-width modulation of the duty-cycle ratio of an output signal.

### DETAILED DESCRIPTION OF THE INVENTION

For illustrative purpose, an energy-saving power converting apparatus according to the invention that has a suspend mode and can be automatically waked up may by way of example be suitable for receiving a mains voltage and converting the mains voltage to a voltage level appropriate to the needs of an electricity consuming device to be powered. However, it is apparent to those skilled in the art that the power converting apparatus according to the invention may be alternatively configured to include a battery in place of taking power from a mains socket.

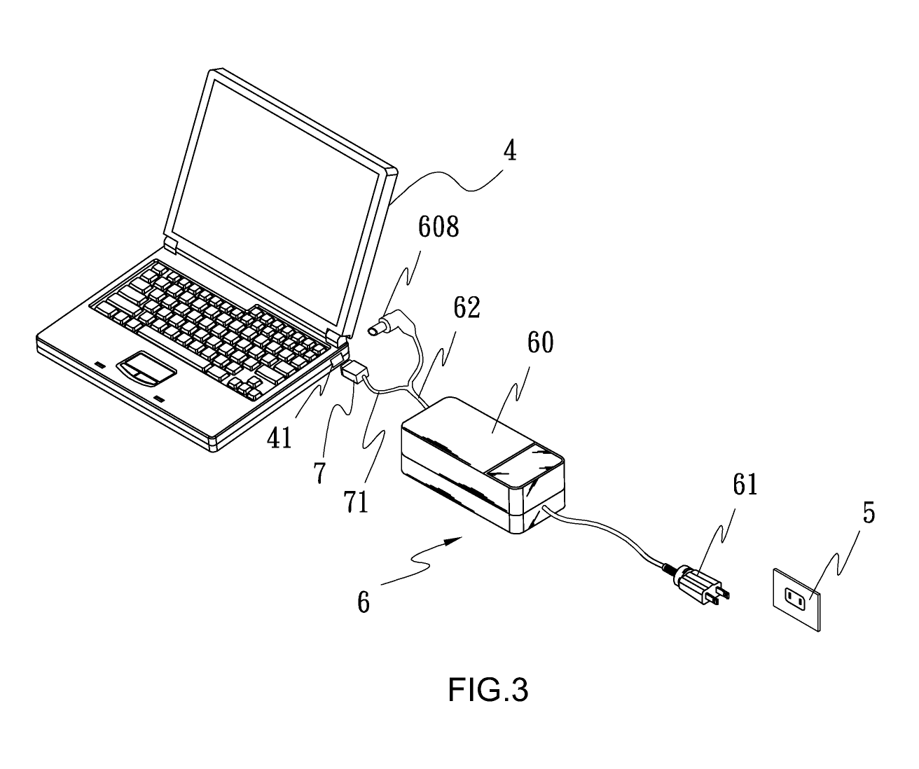

According to the first preferred embodiment of the invention shown in FIG. 3, an electricity consuming device 4 is illustrated as a laptop computer. The turned-off state of the laptop computer is defined herein to be a non-working state. The laptop computer is provided at its lateral side with a standard interface which is illustrated herein as a universal serial bus (USB) connection port 41. The USB connection port 41 has a power terminal and a signal terminal and is adapted for receiving a state indicator 7. The state indicator 7 is electrically connected to a voltage converter 60 of a power converting apparatus 6 via a transmission cord 71. The transmission cord 71 is partially integrated with a power cord 62, so that the two cords are combined into a single cord.

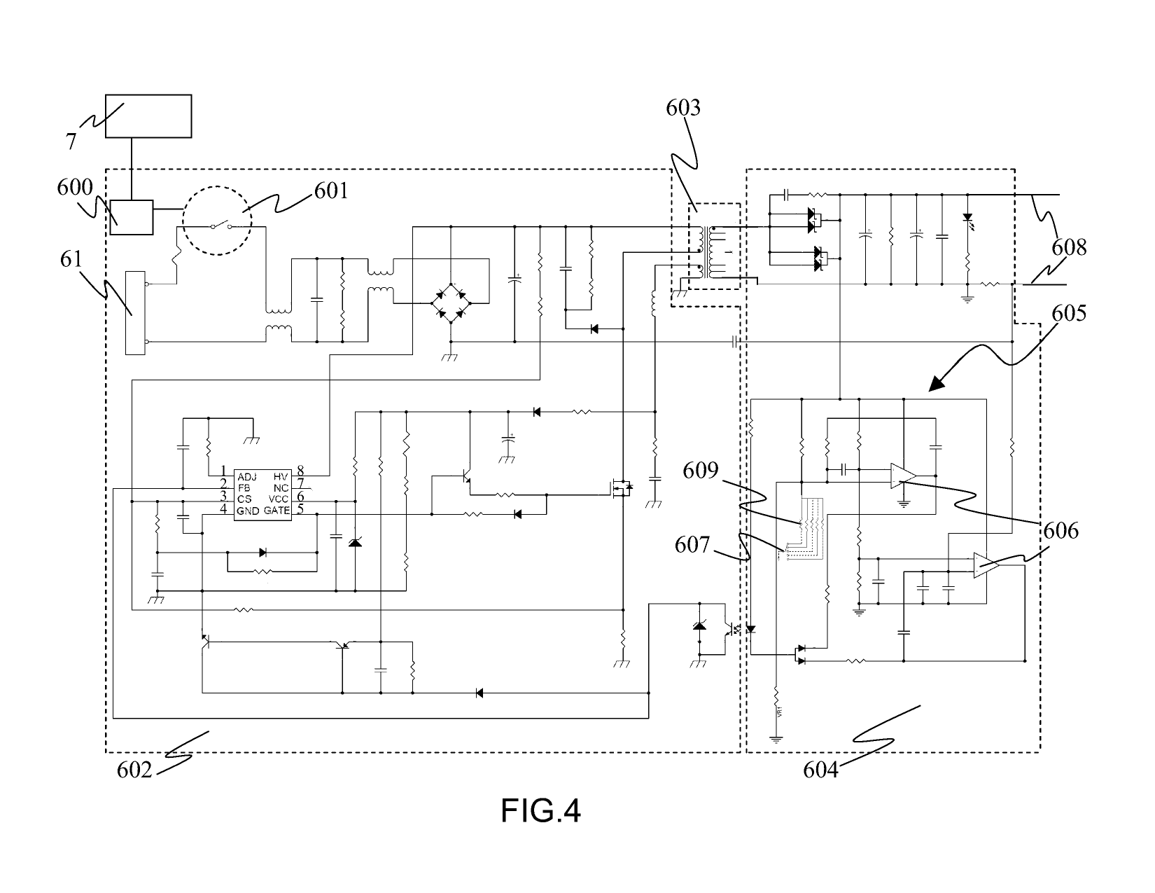

Referring together to FIG. 4, the voltage converter 60 takes mains power from a socket 5 via an input port 61, and the incoming voltage is converted into an output voltage by a voltage-transforming unit 605 and finally provided to the electricity consuming device 4. In order to save the energy consumption by the voltage converter 60 during the course when the electricity consuming device 4 is placed in the non-working state, the voltage converter 60 according to this embodiment further includes a control switch 601 for placing a primary side circuit 602 in either an electrically connected state or an electrically disconnected state, and a receiving and controlling unit 600 for receiving a signal from the transmission cord 71. When the electricity consuming device 4 is placed in a working state, the USB connection port 41 takes power from the electricity consuming device 4 and, in turn, provides power to the state indicator 7 through the power terminal. The state indicator 7 then transmits a signal to the receiving and controlling unit 600 via the transmission cord 71, so as to notify the receiving and controlling unit 600 that the electricity consuming device 4 is normally operating and allow power to be supplied to the electricity consuming device 4.

When the computer is turned off and enters the non-working state, the terminals of the USB connection port 41 will not transmit any power or signal and the state indicator 7 will not receive power from the power terminal. As a result, the receiving and controlling unit 600 will not receive any electrical signal from the transmission cord 71, whereby the receiving and controlling unit 600 is notified of the status of the electricity consuming device 4 and turns off the control switch 601 which in turn places the primary side circuit 602 in the electrically disconnected state. Therefore, the primary side circuit 602, inductance coils 603 and the secondary side circuit 604 will not be supplied with power, so that the power converter 60 is placed in a suspend mode in accordance with the non-working state of the electricity consuming device, thereby significantly reducing the power consumption.

On the contrary, in the case where the power converter 60 is already put in the suspend mode, when a user turns on the laptop computer connected thereto, the built-in battery of the computer will provide power to the USB connection port 41 and therefore to the state indicator 7, so that the powering signal is transmitted to the receiving and controlling unit 600 via the transmission cord 71. As a result, the control switch 601 is placed in the electrically connected state, whereby the primary side circuit 602 is activated. The power converter 60 is consequently switched from the suspend mode to a normal operating mode and once again provides power to the electricity consuming device 4.

According to this embodiment, the voltage-transforming unit 605 provided herein is illustrated as one capable of providing different output voltages, in which the voltage-transforming unit is provided to convert an input voltage fed to the input port 61, such as an AC power of 110V, into an output voltage appropriate to the needs of the electricity consuming device, such as a DC power of 19V. In order for being used with various types of electricity consuming devices produced and marketed by different manufacturers, the voltage-transforming unit 605 according to the invention includes amplifiers 606 selectively operated in conjunction with resistor selectors 607, each having a different resistance value, so that the level of the feedback voltage can be changed to such as 12, 15, 18, 19 or 24V DC by switchingly altering the resistance ratio of the resistor connected in series to the amplifiers. For clarity, the resistor circuits which can be selectively placed in an electrically connected state are defined herein as transforming circuits 609. As such, a user can easily select an output voltage appropriate to the needs of the electricity consuming device 4 and allow the selected voltage to be supplied to the electricity consuming device 4 via an output port 608 by manually or automatically adjusting the level of the output voltage.

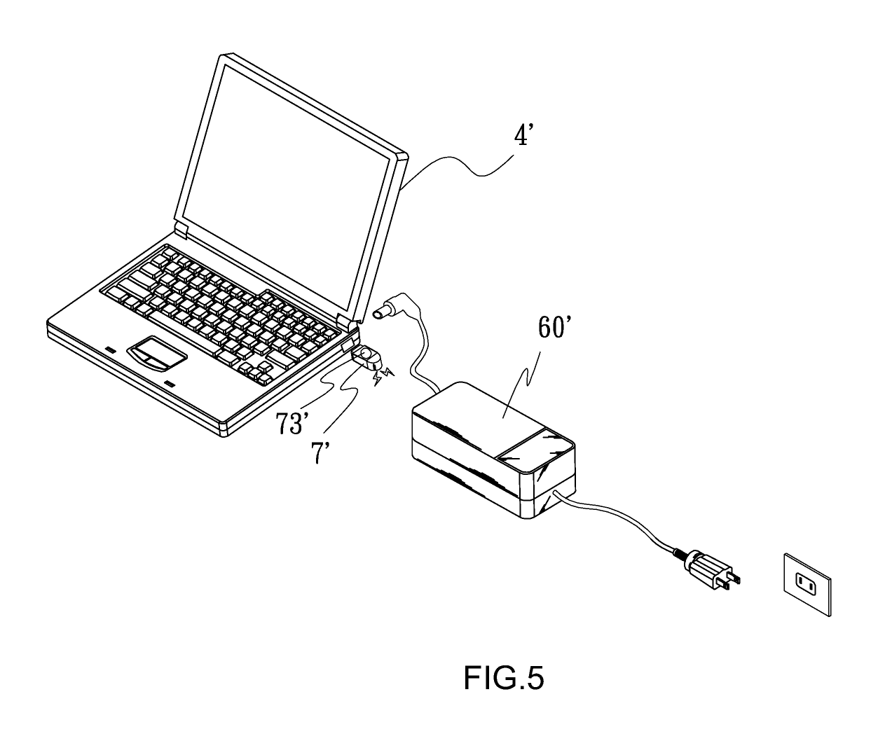

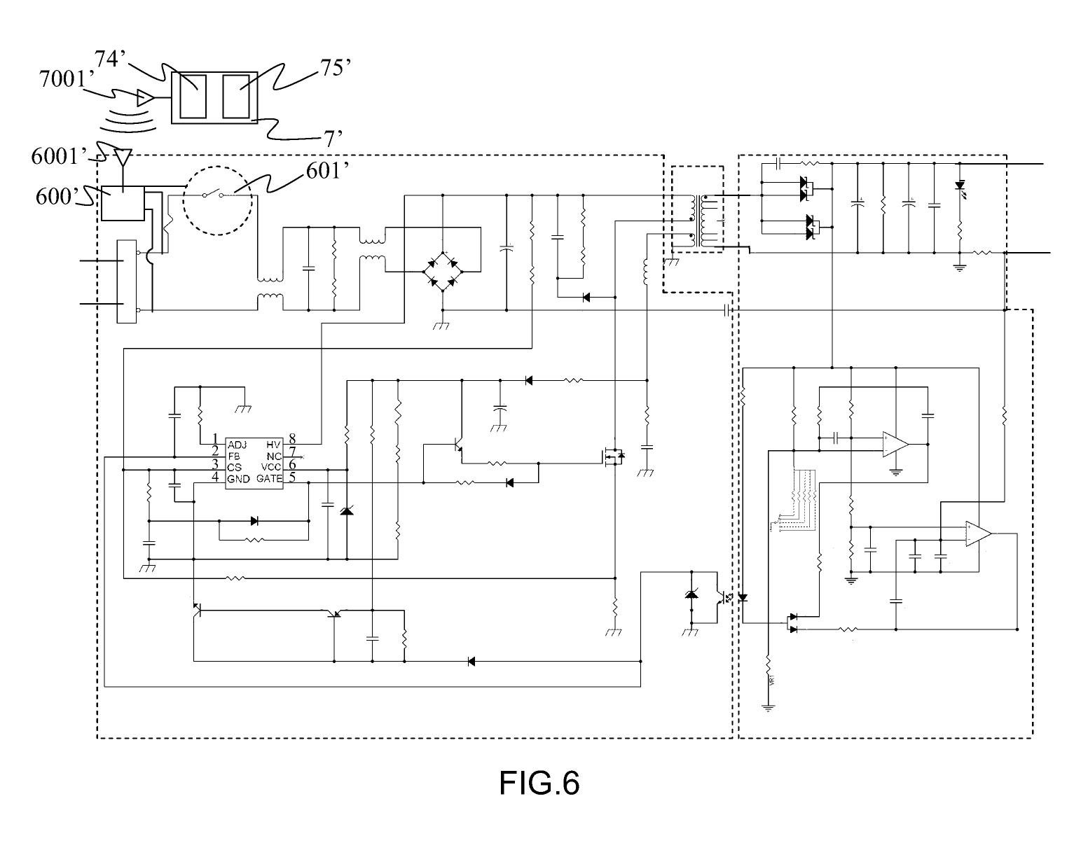

The second preferred embodiment of the invention shown in FIGS. 5 and 6 provides an alternative for users, wherein a state indicator 7′ is controlled by a wireless signal emitting circuit 7001′. When an electricity consuming device 4′ is in the working state, the state indicator 7′ takes power from a power terminal of a standard interface and transmits intermittently and wirelessly a signal to a wireless signal receiving circuit 6001′ provided in a receiving and controlling unit 600′ of a power converter 60′, whereby the receiving and controlling unit 600′ is notified of the status of the electricity consuming device 4′. As a result, the control switch 601′ remains placed in an electrically connected state, by which the power converter 60′ is kept to supply power. Especially, the state indicator 7′ according to this embodiment is further provided with an energy storage unit 74′, which is illustrated herein as a rechargeable battery, and a drive unit 75′, so as to increase the operation flexibility. A push button 73′ is mounted in the exterior of the state indicator 7′, so that a user may pull out the state indicator 7′ from the standard interface and manually press the push button 73′, thereby enabling the drive unit 75′ to drive the wireless signal emitting circuit 7001′ to emit a signal in a wireless manner which in turn commands the power converter 60′ to be in the ON or OFF state.

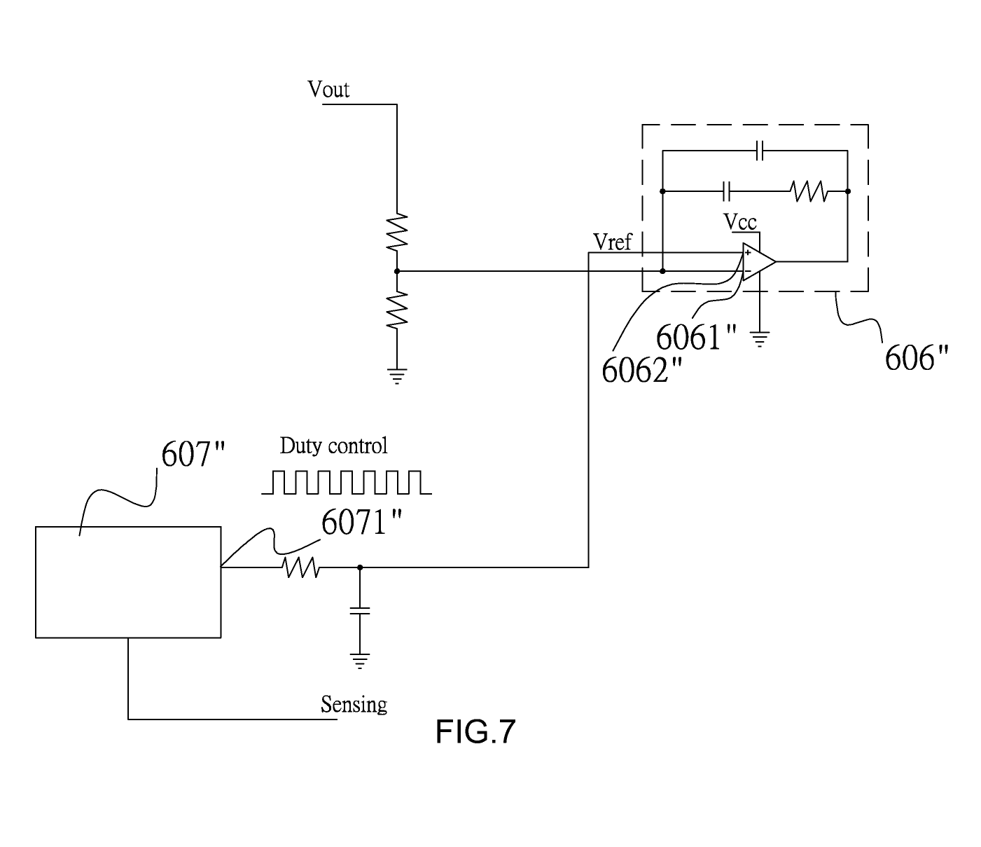

It is readily apparent to those skilled in the art that the voltage-transforming unit may change the output voltage in various manners. According to the third preferred embodiment shown in FIG. 7, the voltage may be modulated by adjusting the duty-cycle ratio of an output signal. The voltage-transforming unit includes an amplifier 606″, with the output terminal thereof being feedback-connected to the inverting input terminal 6061″ and the non-inverting input terminal 6062″ being connected to a pulse-width modulation (PWM) output terminal 6071″ of a sensor controller 607″. The voltage to be output from the amplifier 606″ may therefore be changed by adjusting the duty-cycle ratio of the output signal from the sensor controller 607″. For example,

20V×high level 95%+0V×low level 0.05%=19V;

20V×high level 90%+0V×low level 0.10%=18V;

20V×high level 75%+0V×low level 0.25%=15V; and

20V×high level 60%+0V×low level 0.4%=12V.

The voltage may therefore be changed by adjustment of the duty-cycle ratio.

According to the foregoing disclosure, the inventive energy-saving power converting apparatus can stop the power consumption of most of the circuits in the power converter when it need not supply power, thereby achieving the energy-saving purpose and prolonging the lifespan of constituting components. Meanwhile, the energy-saving power converting apparatus according to the invention has a user-friendly design that allows itself to automatically operate upon detecting that a user turns on an electricity consuming device connected thereto.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. An energy-saving power converting apparatus capable of being waked up automatically and having a suspend mode, which is adapted for providing electric power to an electricity consuming device having at least two electricity consuming modes, including a working mode and a non-working mode, wherein the electricity consuming device has a standard plug-and-play type interface having at least one power terminal and at least one signal terminal, the power converting apparatus comprising:
a state indicator adapted for being connected to the standard interface, wherein the state indicator is activated upon receiving power from the power terminal of the standard interface of the electricity consuming device when the electricity consuming device is in the working mode, and wherein the state indicator cannot receive power from the power terminal when the electricity consuming device is in the non-working mode; and
a power converter, including:
an output port for being electrically connected to the electricity consuming device;
a voltage-transforming unit having a control switch and adapted for outputting at least one predetermined output voltage via the output port; and
a receiving and controlling unit for, upon receipt of a signal output from the state indicator when the electricity consuming device is in the non-working mode, placing the control switch in an electrically disconnected state to deactivate the voltage-transforming unit, and for placing the control switch in an electrically connected state to activate the voltage-transforming unit when the electricity consuming device is in the working mode.

2. The power converting apparatus according to claim 1, wherein the receiving and controlling unit comprises a transmission cord electrically connected to the state indicator.

3. The power converting apparatus according to claim 2, further comprising a power cord for electrically connecting the output port to the electricity consuming device, wherein the transmission cord is adapted for being electrically connected to the power terminal to allow electric power to be transmitted from the power terminal to the receiving and controlling unit, and wherein the transmission cord is at least partially integrated with the power cord.

4. The power converting apparatus according to claim 1, wherein the state indicator comprises a wireless signal emitting circuit, and wherein the receiving and controlling unit comprises a wireless signal receiving circuit corresponding to the wireless signal emitting circuit.

5. The power converting apparatus according to claim 4, wherein the state indicator further comprises a drive unit for driving the wireless signal emitting circuit to emit a wireless signal.

6. The power converting apparatus according to claim 5, wherein the state indicator further comprises an energy storage unit for receiving and storing electric power from the power terminal of the standard interface and for supplying electric power to the wireless signal emitting circuit.

7. The power converting apparatus according to claim 1, wherein the voltage-transforming unit comprises transforming circuits for selecting one out of a plurality of predetermined different output voltages and transmitting the selected output voltage to the output port.

8. The power converting apparatus according to claim 1, further comprising an input port for receiving an input voltage and transmitting the input voltage to the voltage-transforming unit, at which the input voltage is converted into the least one predetermined output voltage.

9. The power converting apparatus according to claim 8, wherein the receiving and controlling unit is electrically connected to the input port and adapted for being powered by the input voltage.

10. The power converting apparatus according to claim 8, wherein the voltage-transforming unit comprises an amplifier having an inverting input terminal, a non-inverting input terminal and an output terminal feedback-connected to the inverting input terminal, and a pulse-width modulation output terminal for outputting a compensated pulse-width modulation signal with a variable duty-cycle ratio to the amplifier.
